(19) United States
(12) Patent Application Publication
(10) Pub. No.: US 2005/0289178 A1
(43) Pub. Date: Dec. 29, 2005

(54) Combining data and presentation from multiple sources into a single web page

(76) Inventor: Ian G. Angus, Mercer Island, WA (US)

Correspondence Address: HARNESS, DICKEY, & PIERCE, P.L.C, 7700 BONHOMME, STE 400, ST. LOUIS, MO, 63105, US

(21) Appl. No.: 10/879,656

(22) Filed: Jun. 29, 2004

(51) Int. Cl. G06F 7/00

(52) U.S. Cl. 707/103 X

(57) ABSTRACT

A method is provided for providing requested information to a network user. The method includes storing a packaged data programming library on one or more local servers. The packaged library includes a web page data structure. A remote server receives a request for information that is initiated by a user via a user interface device communicatively connected to the local server. The remote server then sends a response to the user interface device that includes the requested information combined with a library reference or label. The library reference identifies the packaged library stored on the local server. A web browser of the user interface is utilized to resolve the library reference and present a web page to the user that displays the requested information.

### FIELD OF INVENTION

The invention relates generally to communications networks. More specifically, the invention is related to providing a user connected to a local server with information presented in a web page from a remote server without sending data to construct the presentation of the web page from the remote server.

### BACKGROUND OF THE INVENTION

Many know communications network utilize satellite communication links to communicate between two remote locations. Generally, such networks include at least one local server to which a user connects a user interface device, such as a laptop computer, and at least one remote server that communicates with the local server via the satellite link. Typically, these satellite links are very expensive. In at least some known networks, in response to a user request for information or data, the local server communicates the request, along with other data such as security and identification data, to the remote server. The remote server then compiles the requested information and returns a response to the local server. Often this response includes web page data structure that presents the requested information to the user in a dynamic graphical web page format. Web page data structure typically consumes large amount of bandwidth of the satellite link, which further increases the cost of the link.

For example, in the case of a mobile platform, such as an aircraft, bus or ship, the network could include a local onboard server with limited functional capabilities that is connected, via a satellite link, to a remote server having much more powerful functional capabilities. A passenger of the mobile platform could connect a computing interface device to the onboard server and request information, such as information regarding the passenger's destination, that is stored on, or compiled by, the remote server. The remote server may then return the requested information combined with dynamic content, such as web page structure, that is used to display the requested information on the computing interface device. Transmitting such dynamic data consumes a large amount of the satellite link bandwidth that increases the cost of utilizing the satellite link.

Alternatively, the dynamic data content could be stored on the local server so that very little data needs to be transmitted from the remote server. Thus, very little bandwidth would be consumed. However, this would require that the local server comprise much more complex and powerful equipment, which could be cost prohibitive if a network includes a plurality of local servers communicatively connected to the remote server.

Therefore, it would be desirable to provide such a network that utilizes minimal bandwidth and does not require that dynamic data be stored on the local server. It would be further desirable to provide such a system wherein the remote server could manage requests from multiple local servers without having to identify which local server a request came from.

### BRIEF SUMMARY OF THE INVENTION

In one preferred implementation of the present invention a method is provided for providing requested information to a network user. The method includes storing a packaged data programming library on a local server. The packaged library includes a web page data structure. A remote server receives a request for information that is initiated by a user via a user interface device communicatively connected to the local server. The remote server then sends a response to the user interface device that includes the requested information combined with a library reference or label. The library reference identifies the packaged library stored on the local server. A web browser of the user interface is utilized to resolve the library reference and present a web page to the user that displays the requested information.

The features, functions, and advantages of the present invention can be achieved independently in various embodiments of the present inventions or may be combined in yet other embodiments.

### BRIEF DESCRIPTION OF THE DRAWINGS

The present invention will become more fully understood from the detailed description and accompanying drawings, wherein;

FIG. 1 is a simplified block diagram of a communications system for providing requested information to a user in web page format, in accordance with a preferred embodiment of the present invention;

FIG. 2 is a sequence diagram illustrating a sequence of actions performed by the system shown in FIG. 1 to provide the web page format without sending dynamic web page content over a satellite link; and

FIG. 3 is a simplified block diagram of the communications system shown in FIG. 1 in accordance with another preferred embodiment of the present invention.

Corresponding reference numerals indicate corresponding parts throughout the several views of drawings.

### DETAILED DESCRIPTION OF THE INVENTION

The following description of the preferred embodiments is merely exemplary in nature and is in no way intended to limit the invention, its application or uses. Additionally, the advantages provided by the preferred embodiments, as described below, are exemplary in nature and not all preferred embodiments provide the same advantages or the same degree of advantages.

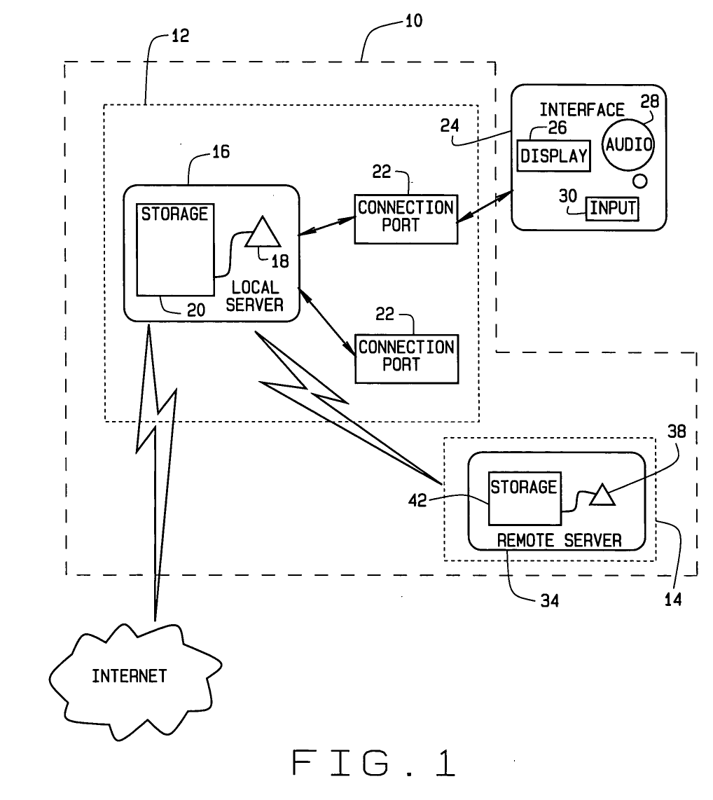

FIG. 1 is a simplified block diagram of a communications system 10. The system 10 includes a local network 12, for example a local area network (LAN), and a remote network 14 that can also be a LAN or alternatively a wide area network (WAN). In one preferred form, the local network 12 is onboard a mobile platform, such as an aircraft, cruise ship, train, bus or any other moving vehicle and the remote network 14 is a ground based network. The local network 12 includes a local server 16 that includes a local processor 18 suitable to execute all functions of local server 16, and at least one local electronic storage device 20. The electronic storage device 20 preferably comprises a computer readable medium, such as a hard drive or any other electronic data storage device for storing such things as software packages or programs, algorithms, information and data. In an alternate embodiment, the electronic storage device 20 is independent of and electrically connected to the local server 16. Additionally, the local network 12 includes a plurality of connection ports 22 communicatively connected, e.g. hard wired or wirelessly connected, to the local server 16.

Each connection port 22 is adapted to communicatively connect to with a user interface 24, e.g. a hard wired or wireless connection. By connecting to a port 22 a user can establish an access link to the local server 16. For example, the user interface 24 can be a laptop computer of a passenger on board an aircraft. The passenger connects the laptop to one of the connection ports 22 to establish a link with the local server 16. The passenger can then utilize the link to access and use one or more services controlled by the local server 16. For example, a passenger can access the Internet via the local server 16.

Generally, each user interface 24 includes a display 26, an audio listening device 28 and a data input device 30. The display 26 is used for viewing such things as information, data and other graphical representations. The audio listening device 28 can be any suitable device for producing sound, such as a headset and jack or a speaker. The data input device 30 allows a user to input information, data and/or queries to the local server 16. For example, the data input device 30 can be a keyboard, a mouse or a touch screen included in the display 26.

The remote network 14 includes a remote server 34 and a remote processor 38 suitable to execute all functions of remote server 34. The remote server 34 also includes at least one remote electronic storage device 42. The electronic storage device 42 preferably comprises a computer readable medium, such as a hard drive or any other electronic data storage device for storing such things as software packages or programs, algorithms, information and data. In an alternate embodiment, the electronic storage device 42 is independent of and electrically connected to the remote server 34.

The local server 16 provides and controls many services that users of the system 10 may desire to utilize. For example, a user may desire to access the Internet via the local server 16. Or, a user may desire to access games and/or other forms of entertainment, such as movies, stored on the storage module 20 and controlled by the local server 16. Or the user may desire to access other information stored on, or compiled by, the remote server 34. For example, a passenger of a mobile platform, e.g. an aircraft, connected to an onboard server may desire information pertinent to the passenger's destination, such as gate arrival and connecting flight information. To access such services controlled by the local server 16 the user connects a user interface 24, such as a laptop computer, to the local network 12 via one of the connection ports 22.

The local server 16 and the remote server 34 communicate with each other using any suitable means of communication, for example land lines, a terrestrial wireless link or a satellite communication link. In a preferred form, communication between the local server 16 and the remote server 34 is achieved using a satellite communication system and method such as that described in U.S. patent application Ser. No. 09/989,742, titled “Method and Apparatus for Providing Bi-Directional Data Services and Live Television Programming to Mobile Platforms”, filed Nov. 20, 2001, and assigned to The Boeing Co. In one preferred form, the means of communication provides direct communication between the local server 16 and the remote server 34. In an alternative preferred form, the means of communication provides indirect communication between servers 16 and 24, e.g. local server 16 can be behind a firewall so that it is effectively invisible to the remote server 34. The communications system 10 is adapted to provide the user with requested information from the remote server. More particularly, the communications system 10 presents the requested information in a web page format without transmitting dynamic content used to construct the web page from the remote server.

In a preferred embodiment, the local storage device 20 has stored thereon at least one or more packaged data programming libraries, preferably a plurality of package libraries are stored on the local storage device 20. Each packaged library includes a programming library, as known in the art, packaged with data structure for an associated web page. The programming libraries included in the packaged libraries can be any suitable programming library, such as a Java Script library. Thus, each packaged library stored on the local storage device 20 not only includes typical programming library data, but further includes web page data structure packaged with the library data. In a preferred form, each packaged library includes substantially all the data structure for essentially the entire web page included in the respective packaged library.

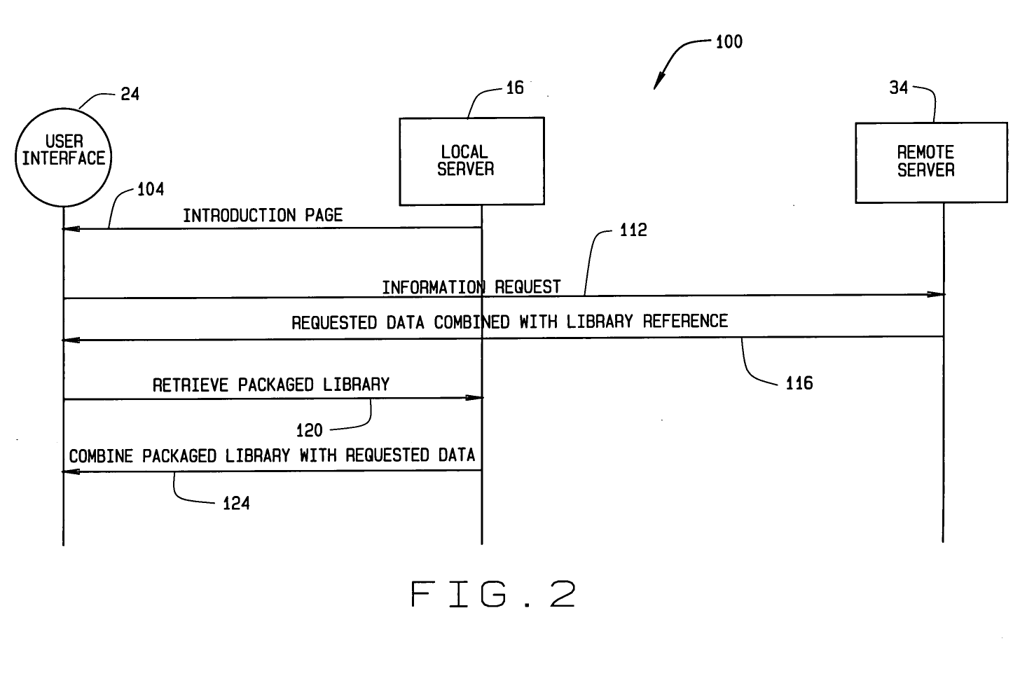

FIG. 2 is a sequence diagram 100 illustrating a sequence of actions performed by the system 10 to present a user with requested information in a web page format. Once a user connects a user interface device 24 to the local network 12, via a connection port 22, the local server 16 sends an introduction web page to the user interface 24 to be hosted on the user interface display 26, as indicated at 104. In one preferred embodiment, when the user interface 24 is connected to the local network 12, the local server presents a login page containing a link to the introduction web page. The user then inputs a request for information, via the input device 30, which is sent directly to the remote server 34, via a satellite link, as indicated at 112. Alternatively, the request for information can pass through the local server 16 without local server 16 interpreting the request. When the remote server 34 receives the request for information, the remote server gathers the requested information. For example, the remote server 34 retrieves the data from the remote storage device 42 or utilizes the remote processor 38 to compile the data.

The remote server 34 then combines the requested information with a library reference, also referred to as a library label, that identifies a specific packaged library stored on the local storage device 20. More specifically, the remote server 34 combines the requested information with one or more library reference that identifies one or more packaged libraries stored on the local storage device 20 that relate to the requested data. The remote server 14 then sends a message comprising the requested information combined with the library reference to the user interface device 24, via the local server 16, as indicated at 116. In a preferred embodiment, the remote server 34 encodes the message prior to sending the message to the passenger interface device 24, thereby reducing the size of the data being sent.

The system 10 utilizes a web browser of the passenger interface 24 to resolve the library reference and requested data then retrieve the packaged library identified by the library reference from the onboard server 16, as indicated at 120. Any supporting data, such as images, can also be retrieved from the local server 16 at this point. In the case where the data in the message is encoded, the user interface web browser uses instruction in the packaged library to decode the data in the message. Finally, the user interface is further utilized to combine the retrieved packaged library with the requested information and present a web page to the passenger displaying the requested information, as indicated at 124.

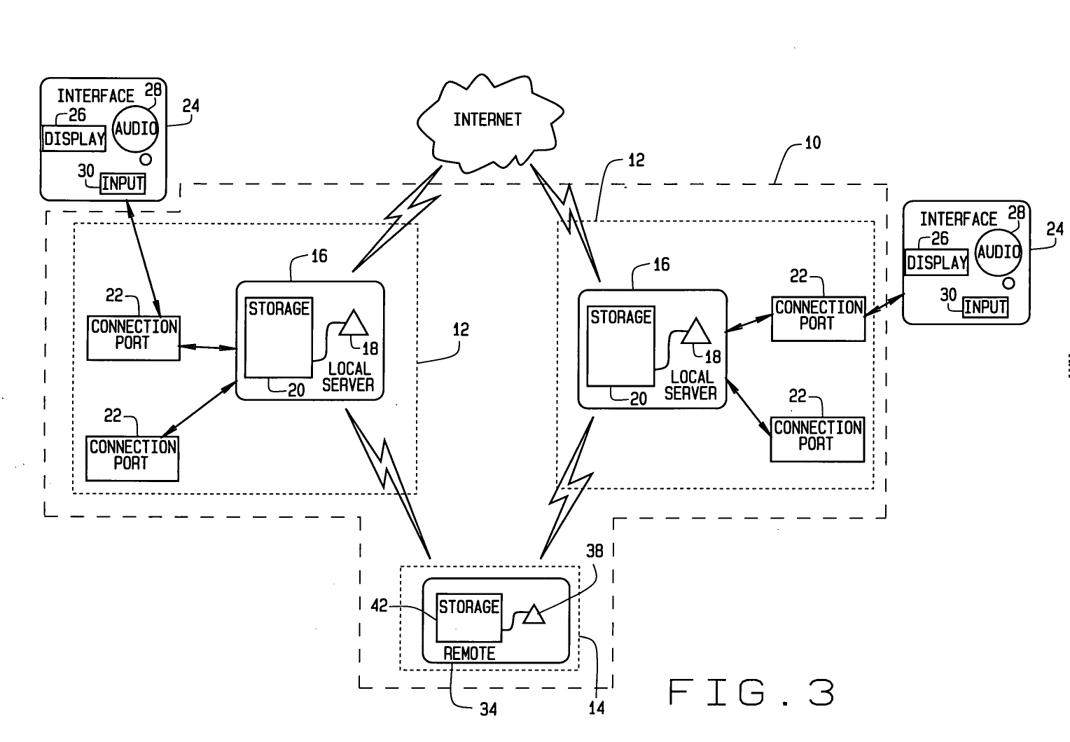

Referring to FIG. 3, in another preferred embodiment the communications system 10 includes a plurality of local networks 12. Each local network 12 is identical in form and function to the local network 12 described above in reference to FIG. 1. Thus, each local network 12 includes a local server 16 and all other components as described above. Additionally, each local server 16 is communicatively connectable to at least one separate and independent user interface device 24. In a preferred embodiment, each local network 12 resides on separate one of a plurality of mobile platforms, such as an aircraft. Therefore, passengers onboard each mobile platform can communicatively connect a user interface device 24, i.e. passenger interface device, to the respective local server 16 that resides on the respective mobile platform. Each of the local networks 12 has one or more packaged libraries stored on the respective local storage devices 20, as described above in reference to FIG. 1.

Furthermore, each local server 16 communicates with the remote server 34 as described above in reference to FIGS. 1 and 2. Therefore, the remote server 34 receives and responds to requests for information from each of the passenger interface devices 24, as described above in reference to FIGS. 1 and 2. More importantly, the remote server 34 will send substantially identical combined messages, that includes substantially identical library references combined with substantially identical requested information in response to the same request for information regardless which local network 12 transmitted the request. That is, the combined message sent from the remote network 14 to a specific local network 12 does not include any data identifying which local network 12 the combined message is transmitted to.

For example, if a passenger onboard an aircraft A and a passenger onboard a aircraft B are flying into airport X and each passenger has the same connecting flight to city M, each passenger can request information regarding a departure gate and time for the connecting flight and the remote network 14 will send substantially identical combined messages to each local network 12. Thus, the remote network 14 does not need to know which local network 12 it is responding to because the combined message only includes the library reference and the requested data.

Typically, in known web page construction, the web page data structure includes the code and data for constructing generally the entire web page and may import a few libraries for miscellaneous data and/or code. The packaged libraries of the present invention include substantially the entire web page data structure, i.e. data and code. Thus, instead of libraries being used to support certain function of a web page, as is known in the art, the packaged libraries of the present invention provide the data structure needed to construct the web page presented to the user to display the requested information. In a preferred implementation the combined message returned from the remote server 34 is a hyper-text markup language (html) page that includes only the library reference and the requested data and no data for constructing the web page ultimately presented on the user interface device 24. All the data and code to construct the web page containing the requested information is contained in the packaged libraries stored on the local storage device 20. Thus, the web page is dynamically computed essentially completely using the user interface web browser.

Thus, the present invention provides requested information, presented in a web page format, without transmitting the web page data structure from the remote server, thereby minimizing the amount of bandwidth used for communication between the local and remote servers.

While the invention has been described in terms of various specific embodiments, those skilled in the art will recognize that the invention can be practiced with modification within the spirit and scope of the claims.

1. A method for providing requested information to a network user, said method comprising:
storing a packaged data programming library that includes a web page data structure on a local server;
receiving a request for information at a remote server, the request initiated by a user via a user interface device communicatively connected to the local server;
sending a response from the remote server to the user interface device, the response including the requested information combined with a library reference identifying the packaged library stored on the local server; and
utilizing a web browser of the user interface to resolve the library reference and present a web page to the user displaying the requested information.

2. The method of claim 1, wherein receiving the request for information at the remote server comprises presenting an introduction page to the user when the user communicatively connects the user interface device to the local server, whereby the user inputs the request for information.

3. The method of claim 1, wherein sending the response from the remote server to the user interface device comprises encoding the requested data.

4. The method of claim 3, wherein utilizing the web browser of the user interface to resolve the library reference and present the web page to the user comprises utilizing the user interface web browser to decode the requested data.

5. The method of claim 1, wherein utilizing the web browser to resolve the library reference and present the web page comprises utilizing the user interface web browser to retrieve the identified packaged library from the local server.

6. The method of claim 5, wherein utilizing the web browser to resolve the library reference and present the web page comprises utilizing the user interface web browser to combine the retrieved packaged library with the requested information returned from the remote server.

7. The method of claim 1, wherein storing the packaged library including the web page data structure on the local server comprises packaging the data programming library to include data structure for essentially the entire web page.

8. The method of claim 1, wherein storing the packaged library including the web page data structure on the local server comprises storing a plurality of packaged libraries on the local server.

9. The method of claim 8, wherein sending the response from the remote server to the user interface device comprises, combining the requested information with at least one of a plurality of library references that identify at least one of the plurality of packaged libraries.

10. The method of claim 1 wherein storing the packaged library including the web page data structure on the local server comprises storing the packaged library on a plurality of local servers.

11. The method of claim 10, wherein the method further comprises:
receiving the request for information at the remote server, the request being initiated by one of a plurality of users having a user interface device communicatively connected to one of the local servers; and
sending the response to the user interface device absent any data identifying which of the local servers the user interface device is communicatively connected to.

12. A communication system for providing requested information to a user, said method comprising:
a local server having a packaged data programming library that includes a web page data structure stored thereon;
a connection port adapted to allow a user to communicatively connect a user interface device to the local server;
a remote server configured to:
receive a request for information, the request initiated by the user via the user interface device; and
send a response to the user interface device, the response including the requested information combined with a library reference identifying the packaged library stored on the local server;
and
a web browser stored on the user interface device, whereby the web browser resolves the library reference and presents a web page to the user displaying the requested information.

13. The system of claim 12, wherein the local server is configured to present an introduction page to the user when the user communicatively connects the user interface device to the local server.

14. The system of claim 12, wherein the remote server is further configured to encode the requested data sent to the user interface device.

15. The system of claim 14, wherein the system is configured to utilize the user interface web browser to decode the requested data.

16. The system of claim 15, wherein the packaged library stored on the local server includes code used by the browser to decode the requested data.

17. The system of claim 12, wherein the system is configured to utilize the user interface web browser to retrieve the identified packaged library from the local server.

18. The system of claim 17, wherein the system is further configured to utilize the user interface web browser to combine the retrieved packaged library with the requested information.

19. The system of claim 12, wherein the packaged library stored on the local server includes data structure for essentially the entire web page.

20. The system of claim 12, wherein the local server has a plurality of packaged libraries including web page structure store thereon.

21. The system of claim 20, wherein the remote server is further configured to combine the requested information with at least one of a plurality of library references that identify at least one of the plurality of packaged libraries.

22. The system of claim 12 wherein the system further includes a plurality of local servers, each local server having the packaged library including the web page data structure stored thereon.

23. The system of claim 22, wherein the remote server is further configured to:
receive the request for information, wherein the request is initiated by one of a plurality of users having a user interface device communicatively connected to one of the local servers; and
send the response to the user interface device absent any data identifying which of the local servers the user interface device is communicatively connected to.

24. The system of claim 12, wherein the remote server comprises one of a terrestrial remote server and a celestial remote server.

25. A method for providing a passenger of a mobile platform with requested information, said method comprising:
packaging a data programming library to include a web page data structure;
storing the packaged library on an onboard server;
presenting an introduction page to a passenger when the passenger communicatively connects a passenger interface device to the onboard server;
receiving a request for information at a remote server, the request initiated by the passenger in response to the introduction page;
retrieving the requested information utilizing the remote server encoding the requested information utilizing the remote server;
combining the requested information with a library label utilizing the remote server, the library label identifying the packaged library stored on the onboard server;
sending the encoded requested data combined with the library label to the passenger interface device;
utilizing a web browser of the passenger interface to decode the requested data, resolve the library label and retrieve the identified packaged library from the onboard server; and
utilizing the passenger interface web browser to combine the retrieved packaged library with the requested information and present a web page to the passenger displaying the requested information.

26. The method of claim 25, wherein packaging the data programming library to include the web page data structure comprises packaging the data programming library to include data structure for essentially the entire web page.

27. The method of claim 25, wherein storing the packaged library on the onboard server comprises storing a plurality of packaged libraries on the onboard server.

28. The method of claim 27, combining the requested information with a library label, comprises combining the requested information with at least one of a plurality of library labels that identify at least one of the of packaged libraries.

29. The method of claim 25 wherein storing the packaged library on the onboard server comprises storing the packaged library on a plurality of onboard servers, each onboard server being onboard a separate mobile platform.

30. The method of claim 29, wherein the method further comprises:
receiving the request for information at the remote server, the request being initiated by one of a plurality of passengers having a passenger interface device communicatively connected to one of the onboard servers; and
sending the encoded data combined with the library label to the passenger interface device absent any data identifying which of the onboard servers the passenger interface device is communicatively connected to.
